(19) United States
(12) Patent Application Publication
(10) Pub. No.: US 2019/0170281 A1
(43) Pub. Date: Jun. 6, 2019

(54) LOCKING SLEEVE APPARATUS

(71) Applicant: NewAge Oilfield Services Inc., Leduc (CA)

(72) Inventors: Peter Mark Lang, Leduc (CA); Brandan Lee Davis, Leduc (CA)

(73) Assignee: NewAge Oilfield Services Inc., Leduc (CA)

(21) Appl. No.: 15/994,767

(22) Filed: May 31, 2018

Related U.S. Application Data
(60) Provisional application No. 62/594,806, filed on Dec. 5, 2017.

(51) Int. Cl. F16L 37/084; F16L 37/092; B21D 39/04; F16L 13/14

(52) U.S. Cl. CPC F16L 37/0841; F16L 37/092; F16L 2201/10; F16L 13/141; B21D 39/046; B21D 39/048

(57) ABSTRACT

There is disclosed a locking sleeve apparatus for securing rotating connection components. In an embodiment, the locking sleeve apparatus comprises: an elongate tube having an inner profile configured to slidingly engage an outer profile of a plurality of rotating connection components; and one or more locking mechanisms positioned internally in the elongate tube near at least one end of the elongate tube; whereby, the plurality of rotating components are mechanically coupled by the elongate tube, and prevented from rotating relative to each other. The inner profile of the elongate tube matches commonly available rotating connection components with multi-sided outer profiles, such as hexagonal nuts. The rotating connection components are configured to rotate in opposite directions relative to each other to tighten or loosen. The one or more locking mechanisms keep the locking sleeve apparatus fitted over the rotating connection components to prevent loosening.

### FIELD

The present invention relates generally to tube and pipe fittings, and more particularly to a locking sleeve apparatus for securing the tube and pipe fitting connections.

### BACKGROUND

Tube fittings provide an extremely convenient way to connect tube sections in the field with little tube preparation. By turning a nut, “ferrules” are deformed such that they plastically deform into the OD of the tubing, thereby creating a metal-to-metal seal, as well as force a cone into the body of the fitting, thereby creating the seal against the fitting. One such tube fitting is a tube fitting system offered by the Swagelok Company. Due to the plastic deformation on the tube OD, these fittings are quite resilient in terms of creating a leak-tight, high pressure seal with very little tubing cleaning, polishing, and preparation in general. However, if compression on the fitting is reduced, the contact stress on the back and front ferrule will also decrease and a leak can result. This is particularly a problem in tube fitting applications in environments where there is vibration, thermal cycling, or both. Threaded connections can come loose, and in the case of bolted connections, repeated transverse displacement of the joint relative to the bolts have been shown to cause nuts to loosen and back off.

Thus, what is needed is a solution to secure tube fittings, particularly in environments subject to vibration.

### SUMMARY

The present invention relates to a locking sleeve apparatus which is configured to secure tube fittings or other threaded connections subject to loosening, particularly in environments subject to vibration, thermal cycling, or both.

In an aspect, the locking sleeve apparatus comprises a sleeve adapted to engage oppositely rotating connection components, such that the connection components impart opposing rotational forces on the locking sleeve apparatus. The locking sleeve apparatus is secured in position over the oppositely rotating connection components by a locking mechanism positioned internally therein.

In an embodiment, the locking sleeve apparatus is an elongate tube having an inner profile configured to slidingly engage the oppositely rotating connection components.

In another embodiment, the inner profile of the locking sleeve apparatus may be hexagonal to match commonly available rotating connection components.

In another embodiment, the oppositely rotating connection components are threaded hexagonal nuts which rotate in opposite directions relative to each other to secure a tube or pipe fitting. Alternatively, the pipe fittings themselves may have hexagonal outer profiles on them which may be tightened relative to each other.

In another embodiment, the locking mechanism is a resiliently flexible locking clip sized and shaped to engage a channel or slot formed into an inner surface of the locking sleeve apparatus.

In another embodiment, the channel or slot formed into the inner surface of the locking sleeve apparatus is positioned near at least one end of the elongate tube of the locking sleeve apparatus, and allows the locking mechanism to be accessible from at least one end of the locking sleeve apparatus.

In another embodiment, the locking sleeve apparatus may include a fixed shoulder or flange at one end with a smaller diameter than the inner surface of the locking sleeve apparatus over most of its length.

In another embodiment, in situations where the oppositely rotating connection components have a different profile, an adapter may be fitted over the smaller connection component to provide a common outer profile for engaging the locking sleeve apparatus.

In another embodiment, corresponding adapters may be fitted over both oppositely rotating connection components to adapt the components to the profile of a locking sleeve apparatus, such that the connection components are prevented from rotating within the locking sleeve apparatus.

In another embodiment, the locking sleeve is sized to provide a press-fit over the connection components.

In another embodiment, the locking sleeve is malleable and mechanically deformable at each end to enable clamping of the locking sleeve in position.

In another embodiment, the locking sleeve apparatus comprises one or more apertures formed through the locking sleeve.

In another embodiment, the one or more apertures are threaded to receive a set-screw to lock the locking sleeve in position.

In another embodiment, the one or more apertures are positioned to receive an adhesive which may be injected internally within the locking sleeve.

In another embodiment, the locking sleeve apparatus further comprises a shrink-tube which when positioned over the locking sleeve and shrunk encapsulates the locking sleeve in position.

In another embodiment, the one or both ends of the locking sleeve are threaded, either internally or externally, to receive a correspondingly threaded nut.

In another embodiment, the locking sleeve is adapted to expand upon heating to be slid over top of the fittings, and adapted to shrink upon cooling over the fittings to keep the locking sleeve in position.

In this respect, before explaining at least one embodiment of the invention in detail, it is to be understood that the invention is not limited in its applications to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1A shows a cross-sectional view of an illustrative example of a tube fitting.

FIG. 1B shows a cross-sectional view of the tube fitting of FIG. 1A with a deformed ferrule as a nut is tightened relative to a body.

FIG. 2A shows a perspective view of an illustrative tube fitting with oppositely rotating connection components, in this example hexagonal nuts.

FIG. 2B shows the tube fitting of FIG. 2A joining two lengths of tubing or pipe, in which the rotating connection components are rotated in opposing directions to tighten the tube fitting onto the tubes or pipes.

FIG. 3A shows a perspective view of an illustrative locking sleeve apparatus positioned adjacent to the tube fitting of FIG. 2B.

FIG. 3B shows a perspective view of the locking sleeve apparatus of FIG. 3A from an opposite end.

FIG. 3C shows a detailed view of a locking mechanism seated within a groove or channel formed in the locking sleeve apparatus.

FIG. 3D shows a partial cross-sectional view of a locking mechanism seated within a groove or channel formed in the locking sleeve apparatus.

FIG. 4A shows a perspective view of the locking sleeve apparatus now fitted over the tube fitting.

FIG. 4B shows a perspective view of the locking sleeve apparatus of FIG. 4A, now with a locking mechanism shown at one end, in this example a resiliently flexible clip positioned internally to the locking sleeve apparatus.

FIG. 4C shows a perspective view of the locking sleeve apparatus of FIGS. 4A and 4B, in which the locking sleeve apparatus is shown as being partially transparent to illustrate how the locking sleeve apparatus is fitted over the tube fitting.

FIG. 4D shows another perspective view of the locking sleeve apparatus now secured in position over the tube fitting.

FIG. 5A shows an illustrative example of a compression style connector having connection components of different size.

FIG. 5B shows an illustrative example of the compression style connector if FIG. 5A fitted to an end of a tube or pipe.

FIG. 5C shows an illustrative example of an adaptor to be fitted on a smaller connection component.

FIG. 5D shows the adaptor of FIG. 5A now fitted over the smaller connection component.

FIG. 6A shows the locking sleeve apparatus positioned to be fitted over the compression style connector with an adapter.

FIG. 6B shows an illustrative view of a partially transparent locking sleeve apparatus to illustrate how the compression style connector and adapter are now fitted within the locking sleeve apparatus.

FIG. 6C shows another view of the locking sleeve apparatus of FIG. 6B now fitted over the compression style connector and adapter of FIGS. 6A and 6B.

FIGS. 7A and 7B show a hex fastener which engages with a coupling as shown in FIG. 7B. Threaded components may be connected locked against the external hex profiles shown in FIG. 7B

FIGS. 8A and 8B illustrated through holes in the locking sleeve located near each end to retain the locking sleeve over the fittings.

FIGS. 9A and 9B show a press-fit type sleeve could be used, with or without a set-screw to help keep the sleeve in position.

FIGS. 10A and 10B show another embodiment, in which a machined shoulder smaller than the diameter of the fitting will prevent passage of the fitting in one direction.

FIGS. 11A and 11B show another embodiment in which each end of the locking sleeve may be mechanically deformed.

FIG. 12 illustrate external stops may be placed on either side of the locking sleeve to keep the locking sleeve in position.

### DETAILED DESCRIPTION

As noted above, the present invention relates generally to tube and pipe fittings, and more particularly to a locking sleeve apparatus for securing the tube and pipe fitting connections.

In an aspect, the locking sleeve apparatus comprises a sleeve adapted to engage oppositely rotating connection components, such that the connection components impart opposing rotational forces on the locking sleeve apparatus. The locking sleeve apparatus is secured in position over the oppositely rotating connection components by a locking mechanism positioned internally therein.

In an embodiment, the locking sleeve apparatus is an elongate tube having an inner profile configured to slidingly engage the oppositely rotating connection components.

In another embodiment, the inner profile of the locking sleeve apparatus may be hexagonal to match commonly available rotating connection components.

In another embodiment, the oppositely rotating connection components are threaded hexagonal nuts which rotate in opposite directions relative to each other to secure a tube or pipe fitting.

In another embodiment, the locking mechanism is a resiliently flexible locking clip sized and shaped to engage a channel or slot formed into an inner surface of the locking sleeve apparatus.

In another embodiment, the channel or slot formed into the inner surface of the locking sleeve apparatus is positioned near at least one end of the elongate tube of the locking sleeve apparatus, and allows the locking mechanism to be accessible from at least one end of the locking sleeve apparatus.

In another embodiment, the locking sleeve apparatus may include a fixed shoulder or flange at one end with a smaller diameter than the inner surface of the locking sleeve apparatus over most of its length.

In another embodiment, in situations where the oppositely rotating connection components have a different profile, an adapter may be fitted over the smaller connection component to provide a common outer profile for engaging the locking sleeve apparatus.

In another embodiment, corresponding adapters may be fitted over both oppositely rotating connection components to adapt the components to the profile of a locking sleeve apparatus, such that the connection components are prevented from rotating within the locking sleeve apparatus.

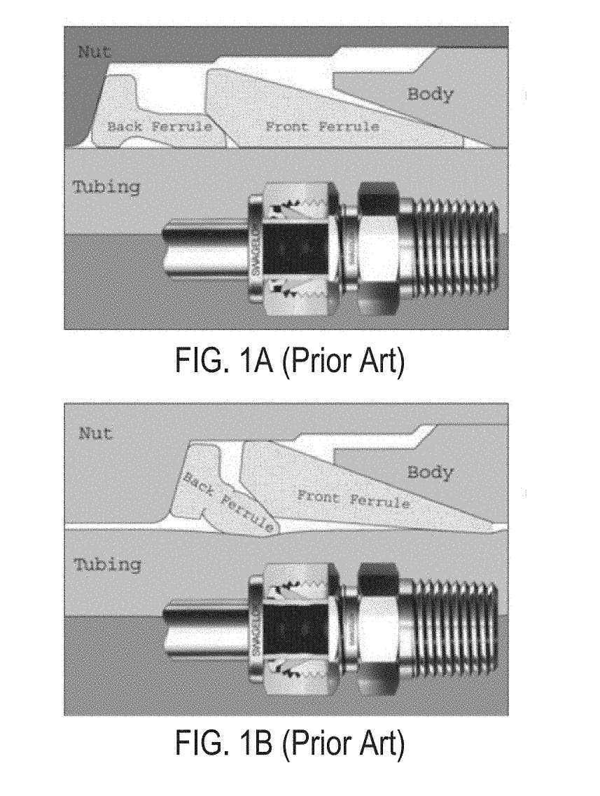

FIG. 1A shows a cross-sectional view of an illustrative example of a tube fitting, as shown by way of example in the Swagelok fitting manual. FIG. 1B shows a cross-sectional view of the tube fitting of FIG. 1A with a back ferrule which deforms as it is pressed against a front ferrule as a nut is tightened relative to a body. The resulting contact between the front ferrule and the body provide two primary tubular seal points. Because of its simplicity and effectiveness, this type of tube fitting is used widely in oil industry, as explained below.

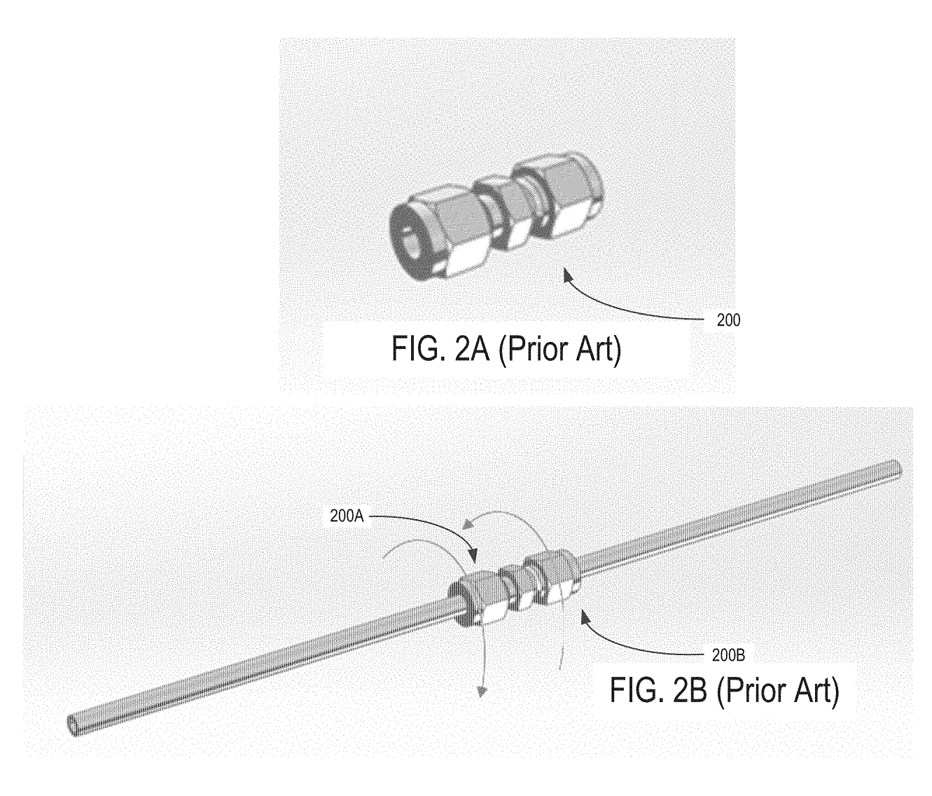

Although FIGS. 1A and 1B illustrate a tube to a National Pipe Thread (“NPT”) type connection by way of example, tube to tube connections 200, as shown in FIG. 2A, are very common in downhole applications, as tube to tube connections 200 allow a field connection between components that may have been shop/lab assembled and tested prior to deployment.

Referring to FIG. 2B, the tube fitting with oppositely rotating connection components 200A, 200B are, in this example, hexagonal nuts of the tube fitting. As shown, the rotating connection components 200A, 200B of the tube fitting are rotated in opposing directions to secure the tube fitting onto the tubes or pipes.

By way of example, in the oil industry, usage of these tube fittings commonly comprise connecting long lengths of ¼ inch tubing to a “turn around” sub—a pressure-tested device that is essentially a U-turn at the end of two parallel ¼ inch capillary lines:

However, a common problem with tube fittings 200 is that they can come loose, particularly in environments where there is vibration. In downhole applications, the mechanism that causes loosening of the nuts 200A, 200B is not as clear. However, the likely culprits are vibration and thermal cycling (displacements caused by repeated thermal expansion and contraction) during a downhole procedure. In any case, loosening of a joint's contact stress can allow a leak, which may have negative and often expensive consequences. The cost to retrieve failed downhole components is high, when considering service rig time and lost well production, let alone the replacement cost of the failed instrumentation or components as a result of the leak.

In order to address this problem, the inventor has developed a locking sleeve apparatus, as will now be described below.

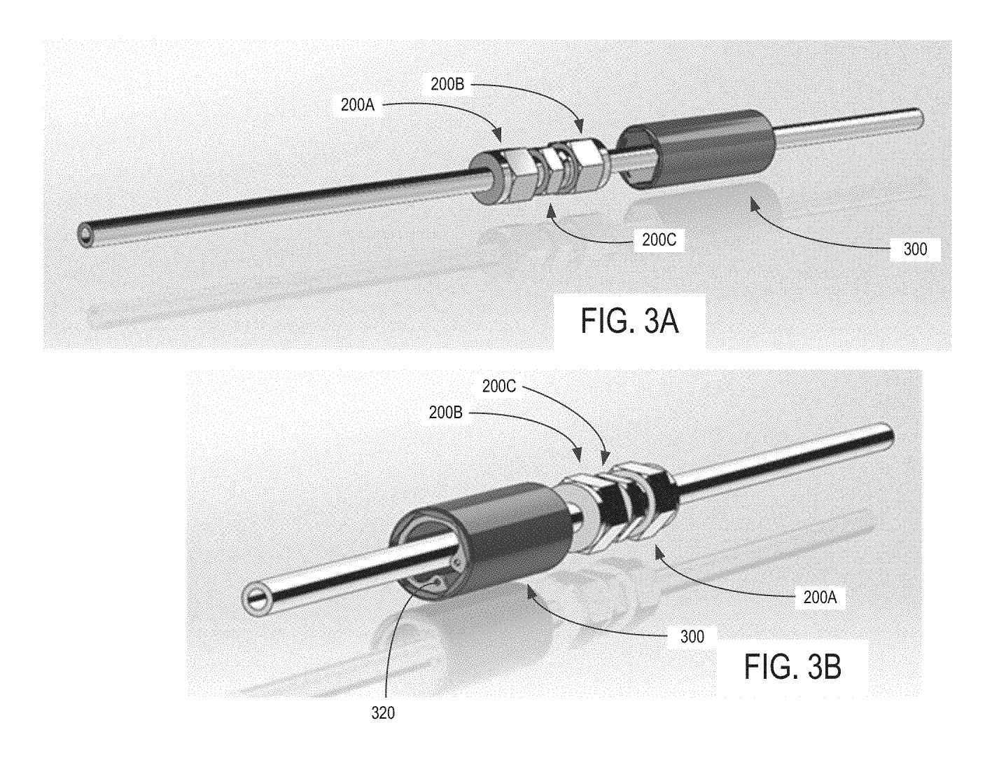

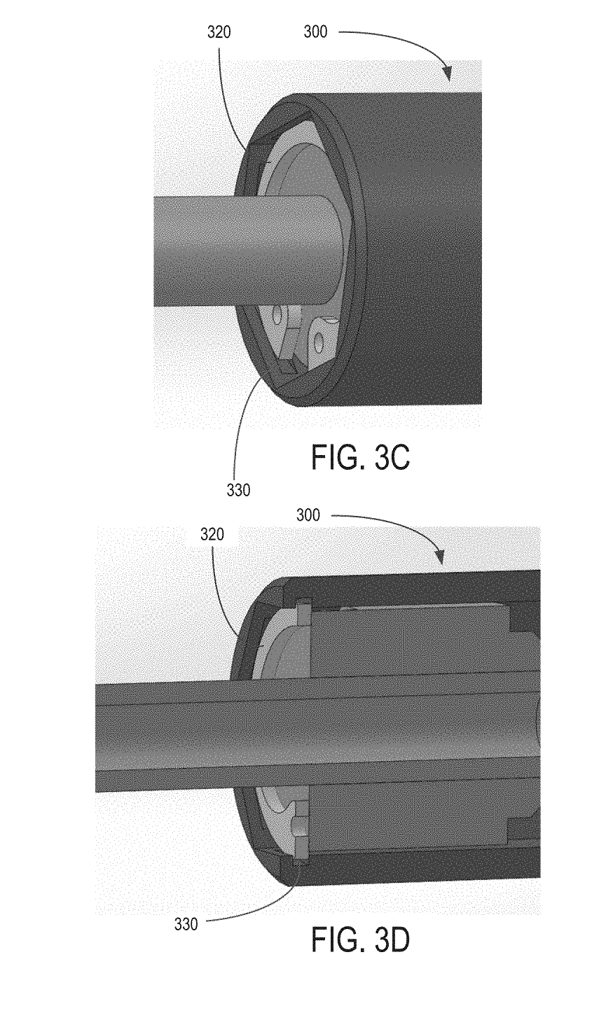

FIG. 3A shows a perspective view of an illustrative locking sleeve apparatus 300 positioned adjacent to the tube fitting 200 of FIG. 2B. When a compression union is installed on a tube (for the first time) each nut 200A, 200B on the fitting is rotated counter clockwise a prescribed number of turns, for example 1.25 times. Each end is done separately, and relative to each other, tightening occurs in opposite directions, as previously shown in FIG. 2B. FIG. 3B shows a perspective view of the locking sleeve apparatus 300 of FIG. 3A from a first end. FIG. 3B shows a perspective view of the locking sleeve apparatus 300 of FIG. 3A from an opposite end, with a locking mechanism 320 shown installed in position.

Still referring to FIGS. 3A and 3B, if one nut is mechanically referenced to the other, the only way one could back off and loosen either nut 200A, 200B is if the loosening force exceeded the tightening force of the other nut 200B, 200A. As will be appreciated, this is impossible as the force to increase joint compression will always exceed that which would tend to break friction and loosen it.

FIG. 3C shows a detailed view of a locking mechanism 320 seated within a groove or channel 330 formed in the locking sleeve apparatus 300. FIG. 3D shows a partial cross-sectional view of the locking mechanism 320 seated within a groove or channel 330 formed in the locking sleeve apparatus 300.

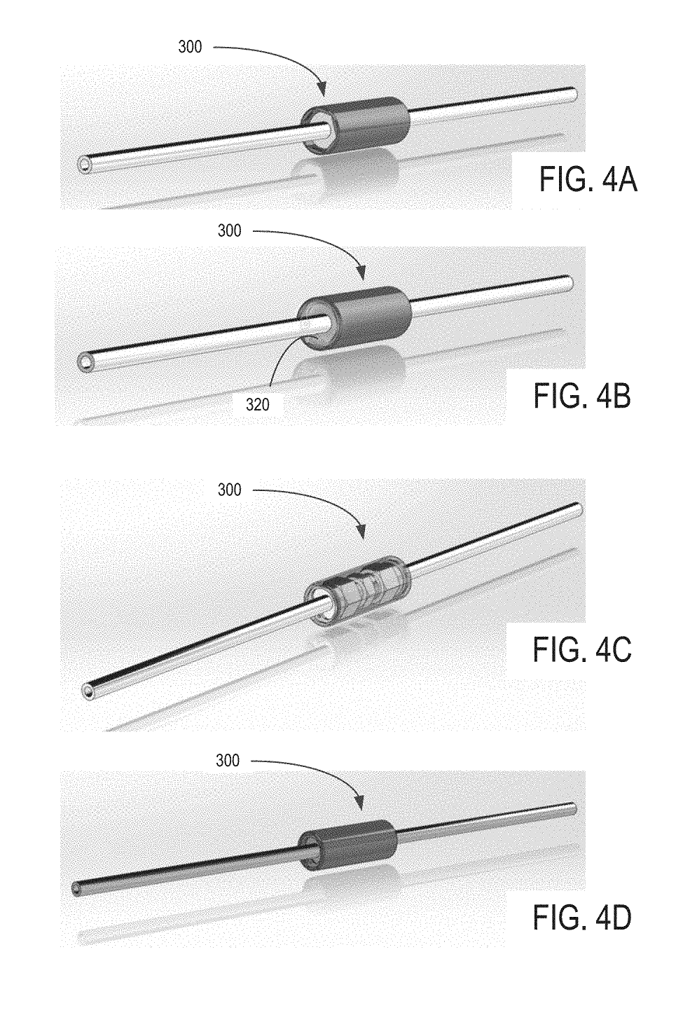

Thus, in an illustrative embodiment, the locking sleeve apparatus 300 is a one-piece cylinder with a hex profile bored through it. As shown in FIG. 4A, the locking sleeve apparatus 300 is now fitted over the tube fitting by slidingly engaging the oppositely rotating bolts 200A, 200B, thereby mechanically coupling them together. For most tube fittings, as earlier shown in FIGS. 3A and 3B, the middle hex 200C on the fitting body is smaller than the nuts 200A, 200B, thereby allowing the sleeve 300 to pass over regardless of angular orientation. In cases where the middle hex 200C is the same size as the nuts 200A, 200B, it simply requires that all hex faces are aligned to allow the locking sleeve apparatus 300 to be fitted over all of the nuts 200A, 200B, 200C.

Now referring to FIG. 4B, shown is a perspective view of the locking sleeve apparatus 300 of FIG. 4A, with locking mechanism 320 shown at one end. In this example, the locking mechanism 320 is a resiliently flexible clip positioned internally to the locking sleeve apparatus 300 and seated within a corresponding inner groove or channel 330 formed in the locking sleeve apparatus. A corresponding locking mechanism 320 may be positioned on the opposite end of the locking sleeve apparatus in order to prevent the locking sleeve apparatus 300 from sliding in either direction. FIG. 4C shows a perspective view of the locking sleeve apparatus of FIGS. 4A and 4B, in which the locking sleeve apparatus 300 is shown as being partially transparent to illustrate how the locking sleeve apparatus 300 is fitted over the tube fitting 200.

FIG. 4D shows another perspective view of the locking sleeve apparatus 300 now secured in position over the tube fitting 200. As shown, with the locking mechanisms 320 secured within the locking sleeve apparatus 300, all of the rotating bolts 200A, 200B are now protected within the sleeve 300, and are prevented from loosening by the counteracting forces of the oppositely rotating bolts 200A, 200B. This solution allows tube fittings 300 to be used in some of the harshest environments, including use in downhole applications in the oil industry.

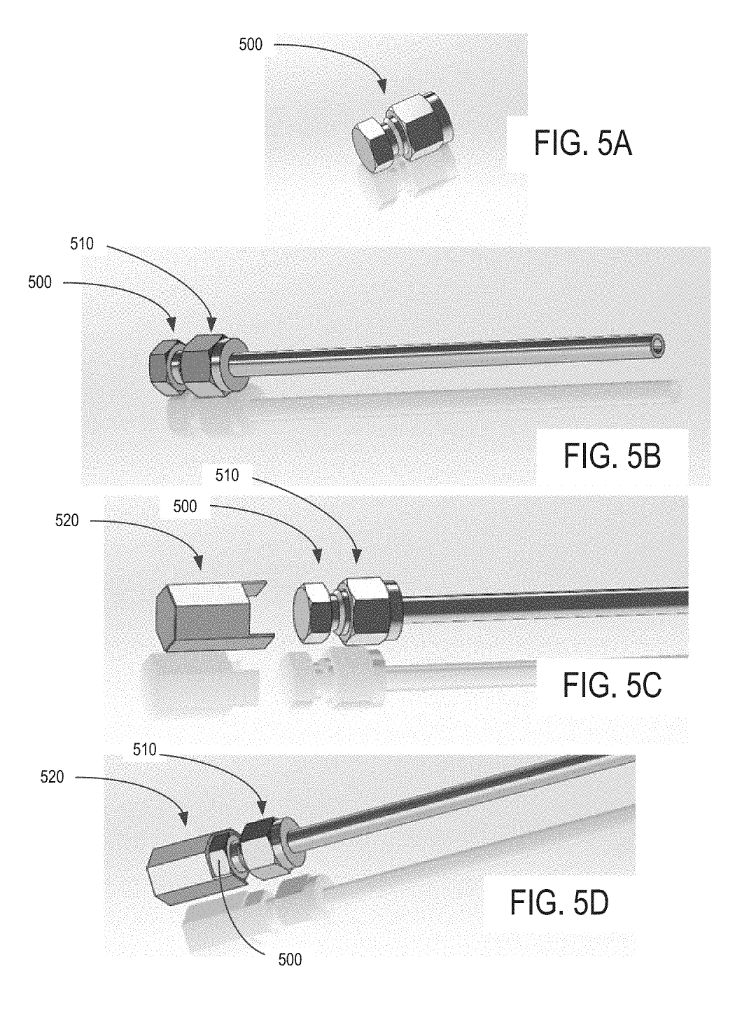

Now referring to FIG. 5A, shown is an illustrative example of a compression style cap connector 500 for use in terminating the end of a tube. The sealing concept is exactly the same as that illustrated earlier in FIGS. 1A and 1B. However, in this case, cap 500 is screwed into a nut 510 to terminate a tube, as shown in FIG. 5B. As previously described, in environments in which there may be significant vibration, the cap 500 may work loose to cause a leak. To prevent this from occurring, the locking sleeve apparatus 300 as described above may be used. An adapter piece 520 may be necessary if the cap 500 is a different size than the nut 510. In this illustrative example, the cap's hex is smaller than the nut hex. Therefore, an adapter 520 may be used over the cap 500 to achieve the same hex size as the nut hex 510 as shown in FIGS. 5C and 5D.

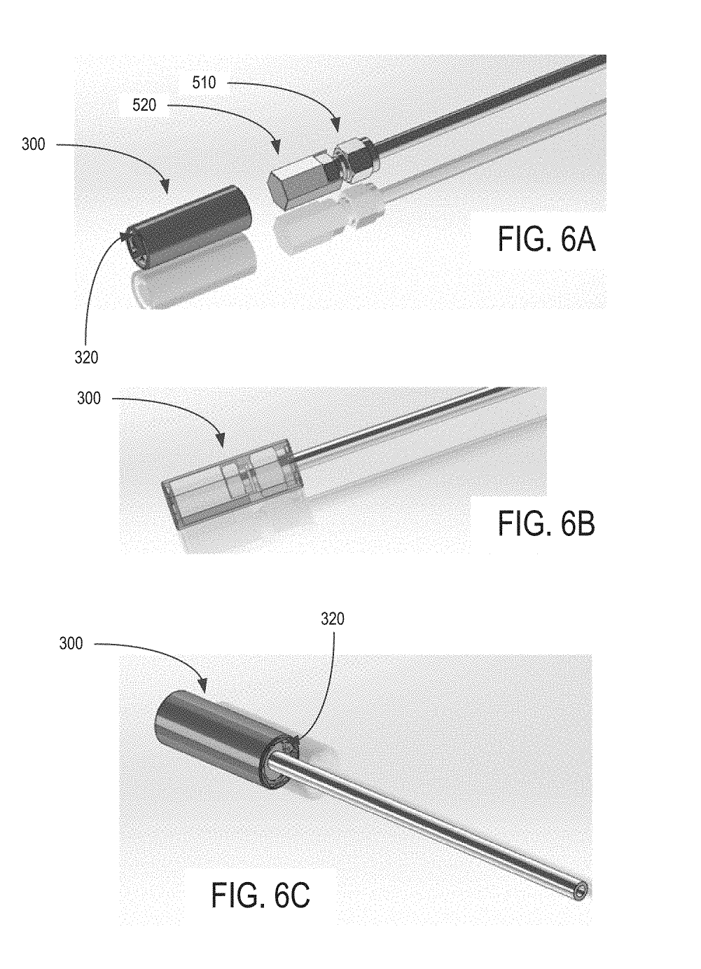

Once this is done, the locking sleeve apparatus 300 may be used to slide over the cap 500 and nut 510 of the compression style connector, and any necessary adapter 520, as shown in FIG. 6A. FIG. 6B shows an illustrative view of a partially transparent locking sleeve apparatus 300 to illustrate how the compression style connector 500, 510 and adapter 520 are now fitted within the locking sleeve apparatus 300.

FIG. 6C shows another view of the locking sleeve apparatus 300 of FIG. 6B, now fitted over the compression style connector 500, 510 and adapter 520 of FIGS. 6A and 6B, with securing mechanisms 320 (e.g. resiliently flexible clips 320) keeping the locking sleeve apparatus 300 in position. This effectively prevents any vibration from loosening the cap from the nut, and therefore allows compression style connectors to be used in harsh environments, such as downhole applications in the oil industry.

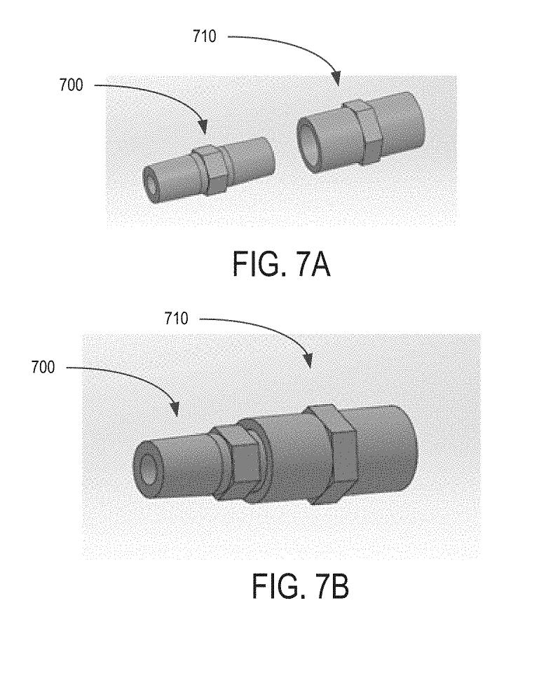

Now referring to FIGS. 7A and 7B, and with reference back to FIGS. 5A to 5D, shown is an alternative locking mechanism for fitting together connectors that are sized differently. As an illustrative example, as shown in FIG. 7A, a hex nipple 700 engages with a coupling 710 as shown in FIG. 7B. Threaded components may be connected locked against the external hex profiles shown in FIG. 7B. In this case, as the size of the hexes are different, a suitable step-up adapter (not shown) may be employed to compensate for the size difference of the smaller hex profile of the hex nipple 700. Once compensated, a locking sleeve apparatus 300 as previously described can be slid over the locking mechanism and secured in position with a locking mechanism 320.

While an illustrative example of one possible locking method has been shown and described, the inventors have also contemplated alternative embodiments for retaining the locking sleeve in position.

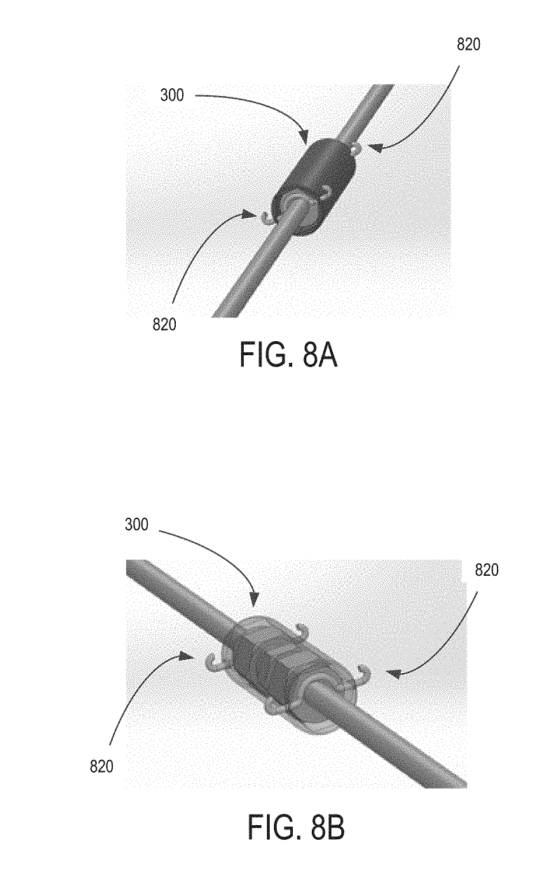

As shown in FIGS. 8A and 8B, in one alternative embodiment, wires 820 may be threaded through corresponding holes in the locking sleeve 300, located near each end to retain the locking sleeve 300 over the fittings (not shown). An illustration of one possible wire configuration is shown in FIGS. 8A and 8B. In this illustrative configuration, the wires 820 straddle each end of the fittings. However, it will be appreciated that the wires 820 could also be threaded through a hole near the middle of the lock (not shown) so that the wire engages with the irregular, reduced diameter geometry of the fitting in the middle section. This would prevent the sleeve from sliding one way or the other, as the wire engages the hex nuts internal to the sleeve 300.

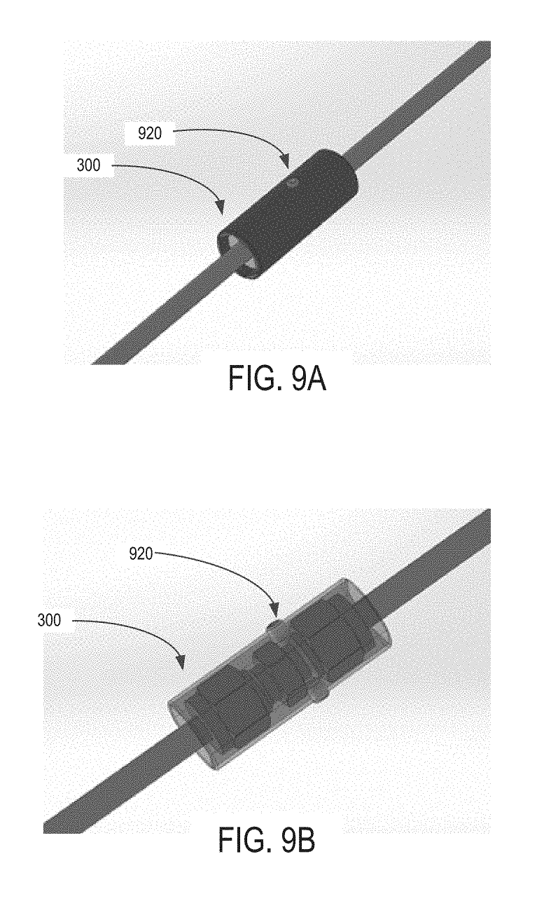

In another embodiment, as shown in FIGS. 9A and 9B, a press-fit type sleeve could be used, with or without a set-screw 920 to help keep the sleeve 300 in position. In this case, although the set screw 920 is a threaded fastener, and therefore subject to loosening in the presence of vibration/thermal cycling, it does not contribute to the locking of the nuts 200A, 200B on the fitting. It is only used to hold the locking sleeve 300 in place. The set screw 920 could be replaced with a press-fit pin as well, to avoid loosening of a set-screw due 920 to vibration.

In another embodiment, set-screws 920 may be configured and positioned to land on a flat of each fitting nut. This would allow sleeve to have a circular inner diameter, making it much easier to manufacture. The sleeve cylinder would still couple the two fitting nuts (via the set screws) and prevent either from backing off.

Multiple pins or set-screws 920 could be used in an angular configuration on a single plane, or in multiple places along the length of the fitting lock, so as to target the recesses in the fitting, and to aid in locking the sleeve 300 in place.

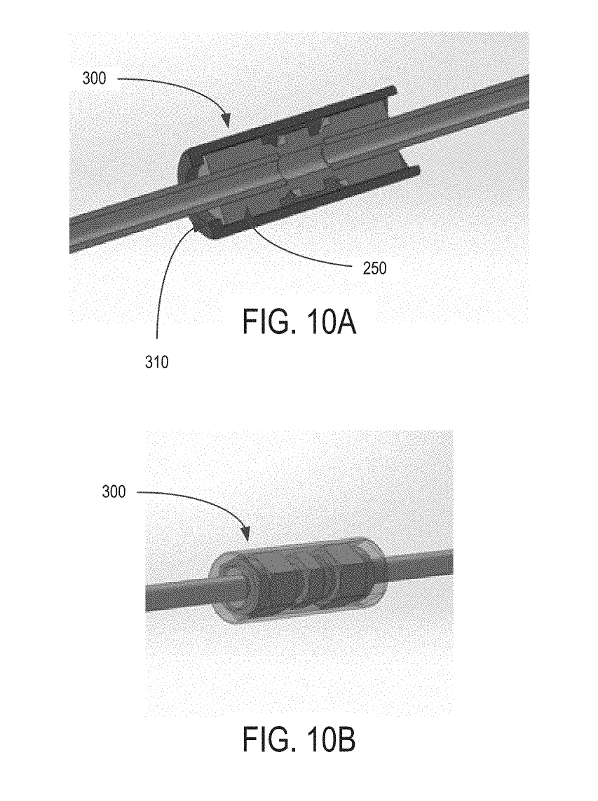

Now referring to FIGS. 10A and 10B, shown is another embodiment, in which a machined shoulder 310 smaller than the diameter of the fitting 250 will prevent passage of the fitting 250 in one direction. This is best shown in FIG. 10A, at the left end of the sleeve 300. The other end of the locking sleeve 300 to the right can be retained by any one of the other methods previously described.

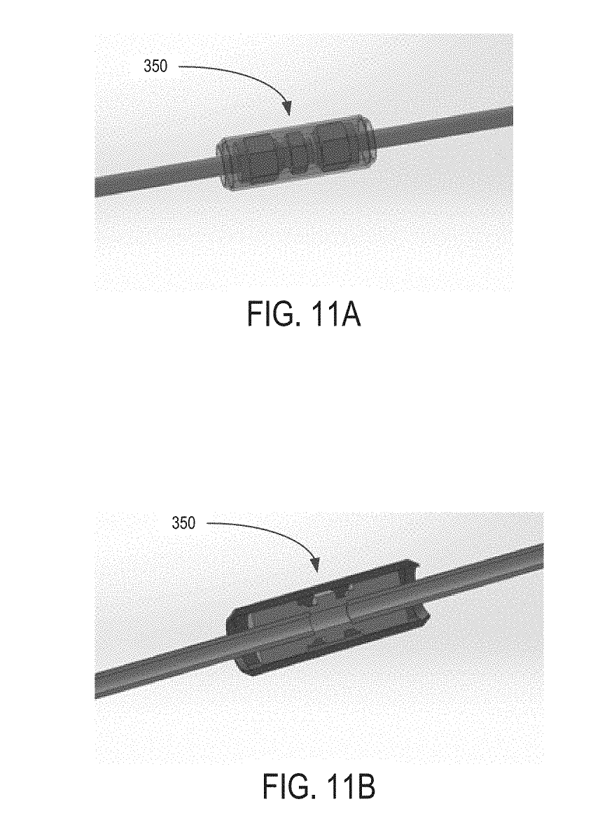

Now referring to FIGS. 11A and 11B, shown is another embodiment in which each end of the locking sleeve 350 may be adapted to be mechanically deformed. For example, using pliers or a hydraulic crimping tool, the ends of the locking sleeve 350 can be plastically deformed to prevent passage of the fitting inside. To loosen and remove the locking sleeve 350, pliers may be used to bend back the edges to allow the fittings to pass through and out of the sleeve 350 at one or both ends.

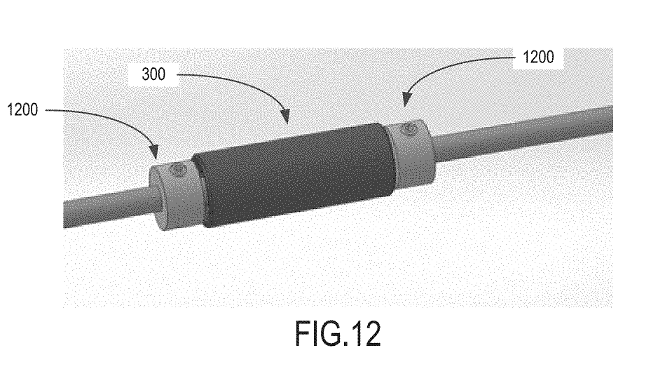

Now referring to FIG. 12, in another embodiment, external stops 1200 may be placed on either side of the locking sleeve 300 to keep the locking sleeve 300 in position. The stops 1200 may be any sort of external object or obstruction that may or may not be attached to the tubing, and which prevents the translation of the locking sleeve past the stops. As an example, this could be a mechanical clamp or a “ball” of glue/epoxy.

A variation of this embodiment could be a shrink-tube placed over the fitting lock and the tubing. Once shrunk down, everything including the locking sleeve is encapsulated, and friction between the shrink-tube and the locking sleeve would prevent movement of the locking sleeve within the shrink-tube.

In yet another embodiment, one or both ends of the locking sleeve may be threaded, either internally or externally, to allow a nut to be attached to the end of the locking sleeve. The nut would be cut radially to allow it to slide over top of the tube, and then attach to the end of the fitting lock, thereby preventing it from translating off of the fitting, and thereby losing fitting nut engagement.

In another embodiment, one or more holes may be drilled radially in through the outer diameter of the locking sleeve, and a glue and/or epoxy of some sort can be injected into the fitting lock, and forced to fill the void spaces in between the tube fitting and fitting lock. The mechanical bond between the glue, fitting lock, and tube fitting would hold it in place. Any means of bonding the fitting to the fitting lock may be used.

In still another embodiment, a slight interference fit would allow the fitting lock to be pre-heated and slid over top of the fitting. Upon cooling, the contraction of the fitting lock would result in compressive forces between the fitting lock and the tube fitting. Friction between the mating surfaces would prevent translation of the fitting lock.

In a similar manner, an interference fit can be created by wedging a material axially, in between the flats of the fitting nuts and the fitting lock. This would be done from either side of the fitting lock to engage both nuts.

Thus, in an aspect, there is provided a locking sleeve apparatus for securing rotating connection components, comprising: an elongate tube having an inner profile configured to slidingly engage an outer profile of a plurality of rotating connection components; and one or more locking mechanisms positioned internally in the elongate tube near at least one end of the elongate tube; whereby, the plurality of rotating components are mechanically coupled by the elongate tube, and prevented from rotating relative to each other.

In an embodiment, the inner profile of the elongate tube matches commonly available rotating connection components with multi-sided outer profiles.

In another embodiment, the rotating connection components are configured to rotate in opposite directions relative to each other to tighten or loosen.

In another embodiment, the elongate tube includes a channel or slot formed into an inner surface to receive the locking mechanism therein.

In another embodiment, the locking mechanism is a resiliently flexible locking clip sized and shaped to engage the channel or slot within the locking sleeve.

In another embodiment, the locking mechanism is accessible from at least one end of the locking sleeve apparatus.

In another embodiment, the locking sleeve apparatus includes a fixed shoulder or flange at one end.

In another embodiment, the locking sleeve apparatus further comprises an adapter for fitting over smaller rotating connection components to provide a common outer profile for engaging the locking sleeve apparatus.

In another embodiment, the locking sleeve is sized to provide a press-fit over the connection components.

In another embodiment, the locking sleeve is malleable and mechanically deformable at each end to enable clamping of the locking sleeve in position.

In another embodiment, the locking sleeve apparatus further comprises one or more apertures formed through the locking sleeve.

In another embodiment, the one or more apertures are threaded to receive a set-screw to lock the locking sleeve in position.

In another embodiment, the one or more apertures are positioned to receive an adhesive which may be injected internally within the locking sleeve.

In another embodiment, the locking sleeve apparatus further comprises a shrink-tube which when positioned over the locking sleeve and shrunk encapsulates the locking sleeve in position.

In another embodiment, one or both ends of the locking sleeve are threaded, either internally or externally, to receive a correspondingly threaded nut.

In another embodiment, the locking sleeve is adapted to expand upon heating to be slid over top of the fittings, and adapted to shrink upon cooling over the fittings to keep the locking sleeve in position.

While illustrative embodiments have been described above, various changes and modifications may be made without departing from the scope of the invention, which is defined by the following claims.

1. A locking sleeve apparatus for securing rotating connection components, comprising:
an elongate tube having an inner profile configured to slidingly engage an outer profile of a plurality of rotating connection components; and
one or more locking mechanisms positioned internally in the elongate tube near at least one end of the elongate tube;
whereby, the plurality of rotating components are mechanically coupled by the elongate tube, and prevented from rotating relative to each other.

2. The locking sleeve apparatus of claim 1, wherein the inner profile of the elongate tube matches commonly available rotating connection components with multi-sided outer profiles.

3. The locking sleeve apparatus of claim 2, wherein the rotating connection components are configured to rotate in opposite directions relative to each other to tighten or loosen.

4. The locking sleeve apparatus of claim 3, wherein the elongate tube includes a channel or slot formed into an inner surface to receive the locking mechanism therein.

5. The locking sleeve apparatus of claim 4, wherein the locking mechanism is a resiliently flexible locking clip sized and shaped to engage the channel or slot within the locking sleeve.

6. The locking sleeve apparatus of claim 5, wherein the locking mechanism is accessible from at least one end of the locking sleeve apparatus.

7. The locking sleeve apparatus of claim 5, wherein the locking sleeve apparatus includes a fixed shoulder or flange at one end.

8. The locking sleeve apparatus of claim 1, further comprising an adapter for fitting over smaller rotating connection components to provide a common outer profile for engaging the locking sleeve apparatus.

9. The locking sleeve apparatus of claim 1, wherein the locking sleeve is sized to provide a press-fit over the connection components.

10. The locking sleeve of claim 1, wherein the locking sleeve is malleable and mechanically deformable at each end to enable clamping of the locking sleeve in position.

11. The locking sleeve apparatus of claim 1, further comprising one or more apertures formed through the locking sleeve.

12. The locking sleeve apparatus of claim 11, wherein the one or more apertures are threaded to receive a set-screw to lock the locking sleeve in position.

13. The locking sleeve apparatus of claim 11, wherein the one or more apertures are adapted to receive a wire through the one or more apertures to lock the locking sleeve in position.

14. The locking sleeve apparatus of claim 11, wherein the one or more apertures are positioned to receive an adhesive which may be injected internally within the locking sleeve.

15. The locking sleeve apparatus of claim 1, further comprising a shrink-tube which when positioned over the locking sleeve and shrunk encapsulates the locking sleeve in position.

16. The locking sleeve apparatus of claim 1, wherein one or both ends of the locking sleeve are threaded, either internally or externally, to receive a correspondingly threaded nut.

17. The locking sleeve apparatus of claim 1, wherein the locking sleeve is adapted to expand upon heating to be slid over top of the fittings, and adapted to shrink upon cooling over the fittings to keep the locking sleeve in position.
